(19) United States
(12) Patent Application Publication
(10) Pub. No.: US 2019/0226255 A1
(43) Pub. Date: Jul. 25, 2019

(54) DOOR HINGE AND METHOD

(71) Applicants: Stephen Fields, Palm Desert, CA (US); Aaron Fields, Palm Desert, CA (US)

(72) Inventors: Stephen Fields, Palm Desert, CA (US); Aaron Fields, Palm Desert, CA (US)

(21) Appl. No.: 16/242,763

(22) Filed: Jan. 8, 2019

Related U.S. Application Data
(60) Provisional application No. 62/621,488, filed on Jan. 24, 2018.

(51) Int. Cl. E05D 11/00; E05D 3/02; E05D 5/04; E05D 9/00

(52) U.S. Cl. CPC E05D 11/0054; E05D 3/02; E05D 5/04; E05D 9/00; E05Y 2201/11; E05Y 2800/674; E05Y 2800/676; E05D 2011/0063; E05Y 2900/132

(57) ABSTRACT

A door hinge includes a door flange. The door flange includes a first-cylindrical portion. The first-cylindrical portion segmented and having an axially vectored borehole therethrough. The door hinge includes a frame flange. The frame flange including a second-cylindrical portion. The second-cylindrical portion segmented and having a corresponding axially vectored borehole therethrough. The first-cylindrical portion and second-cylindrical portion are configured to engage when their respective boreholes are coaxial. A plurality of apertures are disposed on the door flange and the frame flange. A plurality of plugs are included with the door hinge. Each of the plurality of plugs are sized and dimensioned to close at least one of the plurality of apertures. The door hinge is useful for attaching a door to a door frame.

### CROSS-REFERENCE TO RELATED APPLICATION(S)

The present application is related to and claims priority to U.S. Provisional Patent Application No. 62/621,488 filed Jan. 24, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of housing fixtures of existing art and more specifically relates to door hinges.

### RELATED ART

Traditional door hinge assemblies include a door hinge that is used to mount a door to a door frame. Presently, door hinge assemblies use a uniform array of mounting apertures that accept fasteners. The mounting apertures are typically uniformly distributed and in the same location, despite the varying manufactures of the door hinges. A common issue with existing door hinge art arises with the repeated use of a mounting surface. The mounting surface is typically wood, in which an aperture is created that aligns with the mounting aperture of the door hinge. Following repeated use with conventional door hinges, the aperture created in the mounting surface must be reprocessed to secure mounting fasteners. A suitable solution is desired.

U.S. Pat. No. 7,162,774 to Julius von Resch relates to a multi-position adjustable door hinge. The described multi-position adjustable door hinge is comprised of a frame leaf having a lower barrel section and a door leaf having an upper barrel section. An eccentric pivot pin is disposed in axial rotational fit in a through bore of the lower barrel section and is in contact at a lower end with an adjustment screw. The eccentric pivot pin has an upper cylindrical portion eccentrically displaced from the lower cylindrical portion and extends into a cylindrical bore of an eccentric compensator cylinder adjustably retained in the through bore of the upper barrel section. The eccentric pivot pin and the eccentric compensator cylinder are both axially displaceable from one another whereby to impart relative lateral displacement thereof and of the barrels to a desired position. The adjustment screw at the bottom of the lower barrel section provides vertical adjustment between the frame leaf and the door leaf. Set screws are provided to lock the eccentric pivot pin and the eccentric compensator cylinder at the desired position.

### SUMMARY OF THE INVENTION

In view of the foregoing disadvantages inherent in the known door hinge art, the present disclosure provides a novel door hinge. The general purpose of the present disclosure, which will be described subsequently in greater detail, is to provide an effective and efficient door hinge.

A door hinge is disclosed herein. The door hinge includes a door flange. The door flange includes a first-cylindrical portion. The first-cylindrical portion is segmented and having an axially vectored borehole therethrough. The door hinge includes a frame flange. The frame flange includes a second-cylindrical portion. The second-cylindrical portion is segmented and has a corresponding axially vectored borehole therethrough. The first-cylindrical portion and second-cylindrical portion are configured to engage when their respective boreholes are coaxial. A plurality of apertures are disposed on the door flange and the frame flange. A plurality of plugs are included with the door hinge. Each of the plurality of plugs are sized and dimensioned to close at least one of the plurality of apertures.

The present invention provides a standard sized hinge with multiple hole patterns. The multiple hole patterns allow for a door to be reattached to a frame that has been previously used by a conventional door hinge. The hinge of the present invention provides multiple fastener hole options for the installation of a door to a door frame. The fastener holes may be in an arbitrary arrangement or placed in locations that have not previously been used. The immediate innovation of the disclosed door hinge further includes multiple plugs for the arrangement of holes. The plugs may be inserted into unused fastener holes at design preference of the user. Ultimately, the disclosed door hinge provides a means to refasten doors to door frames.

According to another embodiment, a method of installing a door hinge is also disclosed herein. The method of installing a door hinge includes a providing a door hinge as describe above; aligning the door hinge with respective mortises on a frame and a door; fastening the door hinge to the frame and the door with fasteners through a corresponding set of a plurality of apertures and lastly, an optional step of inserting plugs into the plurality of apertures.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a door hinge and method, constructed and operative according to the teachings of the present disclosure.

FIG. 1 is a perspective view of the door hinge according to an embodiment of the disclosure.

FIG. 2 is a top view of the door hinge of FIG. 1, according to an embodiment of the present disclosure.

FIG. 3 is a side view of the door hinge of FIG. 1, according to an embodiment of the present disclosure.

FIG. 4 is a side view of the door hinge of FIG. 1, according to an embodiment of the present disclosure.

FIG. 5 is a flow diagram illustrating a method of installing a door hinge, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a door fixture and more particularly to a door hinge and method as used to improve the existing door hinge art.

Generally, the door hinge kit of the present invention is designed to allow the average homeowner to quickly rehang loose doors without the need to hire a carpenter to re-route new holes. It offers a door hinge with multiple hole patterns and matching hole plugs of the same material. The device effectively eliminates the need to re-route because of damaged holes in the doorjamb and door. It prevents future costs of replacing door hinges and casings and other expensive repairs. The present invention affords specifically designed plates with openings for a versatile fit regardless of door size.

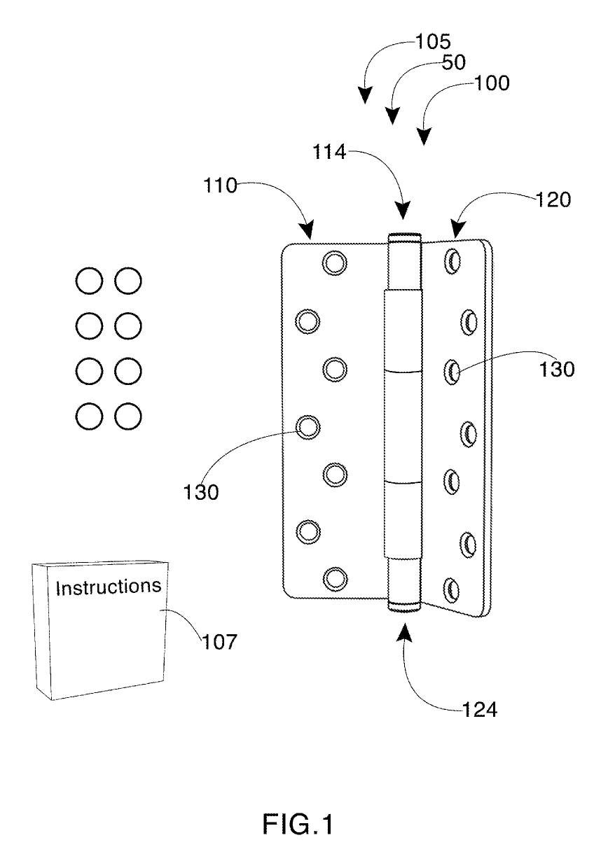

Referring now more specifically to the drawings by numerals of reference, there is shown in FIGS. 1-4, various views of a door hinge 100.

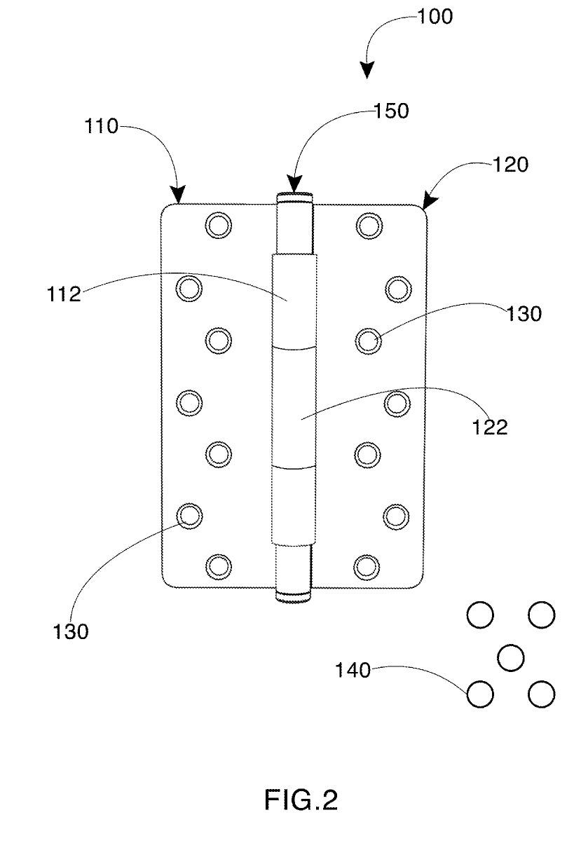

FIG. 1 shows a door hinge 100 during an ‘in-use’ condition 50, according to an embodiment of the present disclosure. Here, the door hinge 100 may be beneficial to attach a door to a frame. As illustrated, the door hinge 100 may include a door flange 110, a frame flange 120, a plurality of apertures 130, and a plurality of plugs 140. The door flange 110 includes a first-cylindrical portion 112 (FIG. 2). The first-cylindrical portion 112 is segmented and has an axially vectored borehole 114 therethrough. In some embodiments, the first-cylindrical portion 112 comprises greater than three segments. The frame flange 120 includes a second-cylindrical portion 122 (FIG. 2). The second-cylindrical portion 122 is segmented and has a corresponding axially vectored borehole 124 therethrough. In some embodiments, the second-cylindrical portion 122 comprises greater than three segments. The first-cylindrical portion 112 and the second-cylindrical portion 122 are configured to engage when their respective boreholes are coaxial. The plurality of apertures 130 are disposed on the door flange 110 and the frame flange 120. The plurality of plugs 140 are sized and dimensioned to close at least one of the plurality of apertures 130.

According to one embodiment, the door hinge 100 may be arranged as a kit 105. In particular, the door hinge 100 may further include a set of instructions 107. The instructions 107 may detail functional relationships in relation to the structure of the door hinge 100 such that the door hinge 100 can be used, maintained, or the like, in a preferred manner.

FIG. 2 shows the door hinge 100 of FIG. 1, according to an embodiment of the present disclosure. As above, the door hinge 100 may include a door flange 110, a frame flange 120, a plurality of apertures 130, and a plurality of plugs 140. The door hinge may further comprise a pin 150. The pin 150 may be sized to fit in the boreholes. The pin 150 may pass through the first-cylindrical portion 112 and the second-cylindrical portion 122 when their respective boreholes are coaxial. The pin 150 may be uniformly cylindric in shape, having an outer diameter similarly sized to the inner diameter of the first-cylindrical portion 112 and the second-cylindrical portion 122. The pin 150 may be configured to provide axial rotation between the door flange 110 and the frame flange 120. The pin 150 may be configured with any conceived structure that provides functional relationship between the door flange 110 and the frame flange 120.

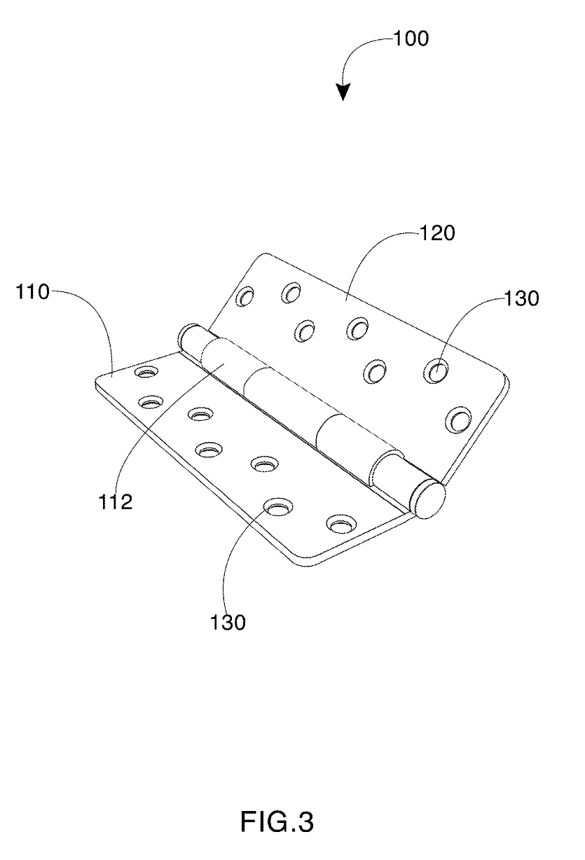

FIG. 3 is another view of the door hinge 100 of FIG. 1, according to an embodiment of the present disclosure. As illustrated, the door hinge 100 may include a door flange 110, a frame flange 120, a plurality of apertures 130, and a plurality of plugs 140 (FIG. 1). The door flange 110 includes a first-cylindrical portion 112. The first-cylindrical portion 112 is segmented and has an axially vectored borehole 114 (FIG. 1) therethrough. The frame flange 120 includes a second-cylindrical portion 122. The second-cylindrical portion 122 is segmented and has a corresponding axially vectored borehole 124 (FIG. 1) therethrough. The first-cylindrical portion 112 and the second-cylindrical portion 122 are configured to engage when their respective boreholes are coaxial. The plurality of apertures 130 are disposed on the door flange 110 and the frame flange 120. The plurality of apertures 130 are sized to receive screw fasteners. The screw fasteners may be screws, nails, bolts, and other applicable fasteners used to secure the door hinge 100 in a static position. The plurality of apertures 130 may include countersinks. The countersink may be sized to receive one of the plurality of plugs 140.

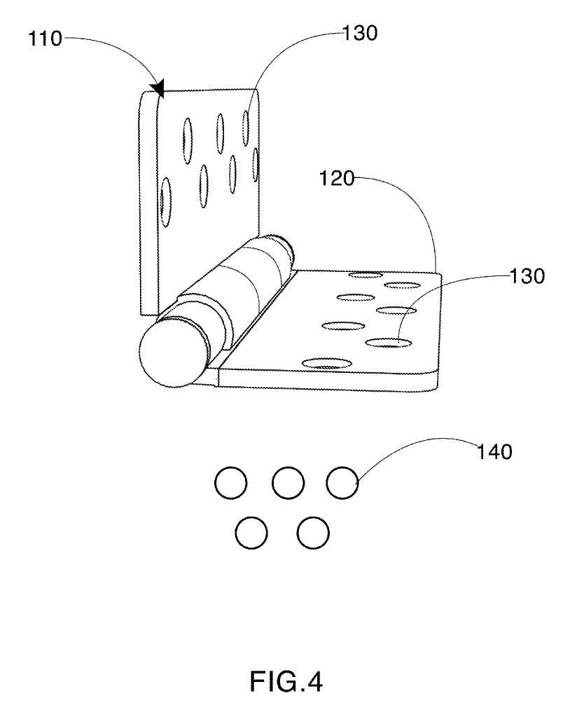

FIG. 4 is another view of the door hinge 100 of FIG. 1, according to an embodiment of the present disclosure. As above, the door hinge 100 may include a door flange 110, a frame flange 120, a plurality of apertures 130, and a plurality of plugs 140. The door flange 110 includes a first-cylindrical portion 112 (FIG. 2). The first-cylindrical portion 112 is disposed on at least one peripheral edge of the door flange 110. The first-cylindrical portion 112 is segmented and has an axially vectored borehole 114 (FIG. 1) therethrough. The frame flange 120 includes a second-cylindrical portion 122. The second second-cylindrical portion 122 is disposed on at least one peripheral edge of the frame flange 120. The second-cylindrical portion 122 is segmented and has a corresponding axially vectored borehole 124 therethrough. The door flange 110 may comprise metal. The frame flange 120 may comprise metal. Other rigid materials including plastics and metal composite materials may be considered.

The immediate innovation of the door hinge 100 may be the plurality of apertures 130 disposed on the door flange 110 and the frame flange 120. The plurality of apertures 130 may be disposed arbitrarily on the door flange 110 and the frame flange 120. In another embodiment, the plurality of apertures 130 may be disposed in a pattern. In some embodiments, the plurality of apertures 130 may be greater than four. The number of apertures 130 and their location on the door flange 110 and the frame flange 120 increase the mounting functionality of the door hinge 100 (FIG. 1). Each of the plurality of apertures 130 is coupled with at least one of the plurality of plugs 140. Each of the plurality of plugs 140 are configured to close each of the plurality of apertures 130. The plurality of plugs 140 may comprise a metal. The plurality of plugs 140 may comprise a plastic. The composition of the plugs 140 may be subject to manufacturing, and user preference.

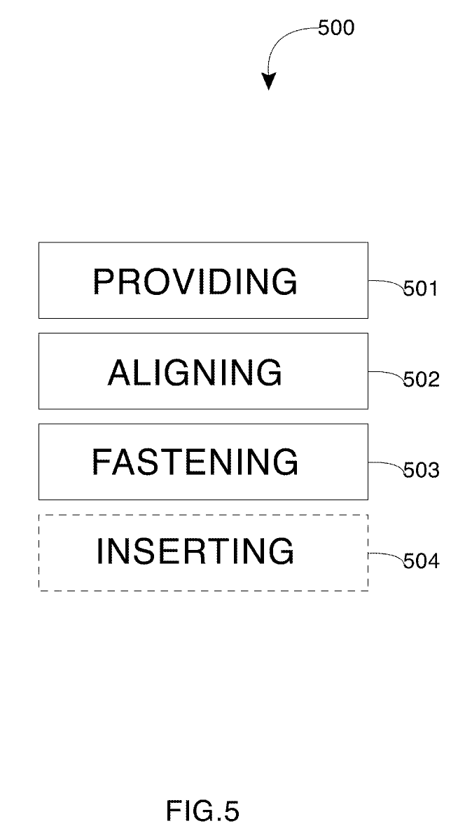

FIG. 5 is a flow diagram illustrating a method for installing 500 a door hinge 100, according to an embodiment of the present disclosure. In particular, the method for installing 500 a door hinge 100 may include one or more components or features of the door hinge 100 as described above. As illustrated, the method for installing 500 a door hinge 100 may include the steps of: step one 501, providing a door hinge comprising a door flange, the door flange including a first-cylindrical portion, the first-cylindrical portion segmented and having an axially vectored borehole therethrough; a frame flange, the frame flange including a second-cylindrical portion, the second-cylindrical portion segmented and having a corresponding axially vectored borehole therethrough, the first-cylindrical portion and second-cylindrical portion configured to engage when their respective boreholes are coaxial; a plurality of apertures, the plurality of apertures disposed on the door flange and the frame flange; and, a plurality of plugs, each of the plurality of plugs are sized and dimensioned to close at least one of the plurality of apertures; step two 502, aligning the door hinge with respective mortises on a frame and a door; step three 503, fastening the door hinge to the frame and the door with fasteners through a corresponding set of a plurality of apertures; step four 504, inserting plugs into the plurality of apertures.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for door hinge installation, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A door hinge comprising:
a door flange, said door flange including a first-cylindrical portion, said first-cylindrical portion segmented and having an axially vectored borehole therethrough;
a frame flange, said frame flange including a second-cylindrical portion, said second-cylindrical portion segmented and having a corresponding axially vectored borehole therethrough, said first-cylindrical portion and second-cylindrical portion configured to engage when their respective boreholes are coaxial;
a plurality of apertures, said plurality of apertures disposed on said door flange and said frame flange; and,
a plurality of plugs, each of said plurality of plugs are sized and dimensioned to close at least one of said plurality of apertures;

2. The door hinge of claim 1, further comprising a pin.

3. The door hinge of claim 2, wherein said pin is sized to fit in said boreholes.

4. The door hinge of claim 2, wherein said pin is configured to provide axial rotation between said door flange and said frame flange.

5. The door hinge of claim 1, wherein said plurality of apertures are sized to receive screw fasteners.

6. The door hinge of claim 1, wherein said first-cylindrical portion is disposed on at least one peripheral edge of said door flange.

7. The door hinge of claim 1, wherein said second-cylindrical portion is disposed on at least one peripheral edge of said frame flange.

8. The door hinge of claim 1, wherein said door flange comprises metal.

9. The door hinge of claim 1, wherein said frame flange comprises metal.

10. The door hinge of claim 1, wherein said plurality of apertures are disposed arbitrarily.

11. The door hinge of claim 1, wherein said plurality of apertures are disposed in a pattern.

12. The door hinge of claim 1, wherein said plurality of apertures is greater than four.

13. The door hinge of claim 1, wherein said plurality of plugs comprise a metal.

14. The door hinge of claim 1, wherein said plurality of plugs comprise a plastic.

15. The door hinge of claim 1, wherein said first-cylindrical portion comprises greater than three segments.

16. The door hinge of claim 1, wherein said second-cylindrical portion comprises greater than three segments.

17. The door hinge of claim 1, further comprising set of instructions; and
wherein the door hinge is arranged as a kit.

18. A method of installing a door hinge, the method comprising the steps of:
providing a door hinge comprising a door flange, said door flange including a first-cylindrical portion, said first-cylindrical portion segmented and having an axially vectored borehole therethrough; a frame flange, said frame flange including a second-cylindrical portion, said second-cylindrical portion segmented and having a corresponding axially vectored borehole therethrough, said first-cylindrical portion and second-cylindrical portion configured to engage when their respective boreholes are coaxial; a plurality of apertures, said plurality of apertures disposed on said door flange and said frame flange; and, a plurality of plugs, each of said plurality of plugs are sized and dimensioned to close at least one of said plurality of apertures;
aligning said door hinge with respective mortises on a frame and a door; and,
fastening said door hinge to said frame and said door with fasteners through a corresponding set of a plurality of apertures.

19. The method of claim 18, further comprising the steps of
inserting plugs into said plurality of apertures.
